(19) United States
(12) Patent Application Publication
(10) Pub. No.: US 2020/0365999 A1
(43) Pub. Date: Nov. 19, 2020

(54) Ka Band Printed Phased Array Antenna for Satellite Communications

(71) Applicant: AvL Technologies, Inc., Asheville, NC (US)

(72) Inventors: Keith Edenfield, Weaverville, NC (US); Ian J. Timmins, Seminole, FL (US); Bruce Barratt, Asheville, NC (US); Alan Eugene Ellis, Candler, NC (US); Erik Leonard, Asheville, NC (US); Peter McMehamin, Asheville, NC (US)

(73) Assignee: AvL Technologies, Inc., Asheville, NC (US)

(21) Appl. No.: 16/877,443

(22) Filed: May 18, 2020

Related U.S. Application Data
(60) Provisional application No. 62/849,657, filed on May 17, 2019.

(51) Int. Cl. H01Q 21/06; H01Q 21/00; H01Q 1/28; H01Q 9/04; H01Q 1/38; H01Q 1/42

(52) U.S. Cl. CPC H01Q 21/065; H01Q 21/0006; H01Q 1/42; H01Q 9/0428; H01Q 1/38; H01Q 1/288

(57) ABSTRACT

A flat panel antenna for satellite communications, the flat panel antenna including a printed circuit board (PCB) including a plurality of patches and a feed network; a waveguide manifold including a transmit feed network on one side and a receive feed network on the opposite side; a transition region on the transmit feed network wherein a waveguide input port transitions to a ridged waveguide for compact dimension; a transition region on the transmit feed network wherein the waveguide input port transitions to the ridged waveguide for compact dimension; an integrated transmit reject filter on the receive feed network; and wherein the flat panel antenna is operable to provide right hand circular polarization TX and left-hand circular polarization RX.

### RELATED APPLICATION

This application claims the benefit of U.S. Provisional Patent Application Ser. No. 62/849,657 filed on May 17, 2020.

### FIELD OF INVENTION

This invention relates to flat panel antennas and, more specifically, a flat panel antenna having a hybrid waveguide and printed circuit structure.

### BACKGROUND OF THE INVENTION

The use of flat panel antennas for man pack and fly away application is of increasing interest in the marketplace. The flat form factor makes it more easily transportable and configured for use than a conventional parabolic reflector. The disadvantage of a flat panel antenna is that it suffers performance degradation when compared to their parabola-based antenna counterparts, mainly in radiation pattern degradation and increased loss through the printed circuits and subsequent feed network.

Accordingly, there exists a need for a flat panel antenna having a hybrid waveguide and printed circuit structure for limiting radiation pattern degradation.

### SUMMARY OF THE INVENTION

In accordance with one form of the present invention, a flat panel antenna for satellite communications is provided, the flat panel antenna including a printed circuit board (PCB) including a plurality of patches and a feed network; a waveguide manifold including a transmit feed network on one side and a receive feed network on the opposite side; a transition region on the transmit feed network wherein a waveguide input port transitions to a ridged waveguide for compact dimension; a transition region on the transmit feed network wherein the waveguide input port transitions to the ridged waveguide for compact dimension; an integrated transmit reject filter on the receive feed network; and wherein the flat panel antenna is operable to provide right hand circular polarization TX and left-hand circular polarization RX.

In accordance with another form of the present invention, a printed circuit board (PCB) and waiveguide manifold assembly for satellite communications, the PCB and waveguide assembly including a top cover layer with integrated radome; a PCB layer including a plurality of patches and a feed network; a waveguide manifold layer; an adhesive between the PCB layer and the waveguide manifold layer; a bottom cover; an adhesive between the waveguide manifold layer and the bottom cover; a transition region on the transmit feed network wherein a waveguide input port transitions to a ridged waveguide for compact dimension; a transition region on the transmit feed network wherein the waveguide input port transitions to the ridged waveguide for compact dimension; an integrated transmit reject filter on the receive feed network; and wherein the flat panel antenna is operable to provide right hand circular polarization TX and left-hand circular polarization RX.

### BRIEF DESCRIPTION OF THE DRAWINGS

For a fuller understanding of the nature of the present invention, reference should be made to the following detailed description, taken in conjunction with the accompanying drawings in which:

FIG. 1 illustrates an ideal Azimuth cut showing directivity of a flat panel array;

FIG. 2 illustrates an ideal Elevation cut showing directivity of a flat panel array;

FIG. 3 illustrates the directivity of a flat panel antenna;

FIG. 4 is a top plan view of a printed circuit antenna array showing rectangular patches and the feed network on a common layer;

FIGS. 5A and 5B illustrate radiation patterns from printed antenna arrays showing gain increase at boresight;

FIG. 6 is a perspective view of the top surface of the waveguide manifold showing TX feed routing on an aluminum plate;

FIG. 7 is an isolated view of the waveguide manifold taken from FIG. 6;

FIG. 8 is a perspective view of the waveguide manifold;

FIG. 9 is an isolated view of the waveguide manifold illustrating the transition from the standard waveguide to ridged waveguide;

FIG. 10 is a perspective view of the RX waveguide manifold with integrated TX reject filter;

FIG. 11 is an isolated view taken from FIG. 10;

FIG. 12 is an isolated view taken from FIG. 10;

FIG. 13 is a top plan view illustrating the printed circuit board (left) and the waveguide manifold (right) and showing how the printed circuit board is placed on top of the waveguide manifold;

FIG. 14 is a diagram showing the PCB stackup for the Ka band phased array antenna;

FIG. 15 illustrates the feed network showing lightbulb like elements that compromise the PCB segment of the waveguide to PCB transition, the striplines, and probes on the end of the lines which feed the patches as a proximity fed configuration;

FIG. 16 illustrates multiple identical feed networks replicated in the PCB such that the same footprint is used repeatedly in the PCB, thereby allowing for easy scaling up or down of the size of the overall antenna to meet gain requirements;

FIG. 17 illustrates the PCB ground layer showing copper openings for interface from printed circuit board to waveguide manifold for 2 sub-arrays—TX narrow in the middle, RX wider on the top (2ea×2);

FIG. 18 illustrates the top copper layer showing patches embedded in the ground plane;

FIG. 19 illustrates the middle PCB feed layer showing stripline traces from each PCB to waveguide interface feeding both TX and RX sub-arrays (8×8 subarrays);

FIG. 20 illustrates the bottom PCB layer showing ground plane with TX and RX interfaces between the PCB to the waveguide manifold, where the slots allow coupling through the bottom of the PCB to each sub array feed network;

FIG. 21 is an isolated view of the TX and RX patches; and

FIG. 22 is an exploded view of the entire PCB and waveguide manifold assembly with covers and conductive adhesives as well as radome.

Like reference numerals refer to like parts throughout the several views of the drawings.

### DETAILED DESCRIPTION OF THE PREFERRED EMBODIMENTS

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims. Referring to the several views of the drawings, the flat panel antenna is shown and described herein and is generally indicated as 10.

The flat panel antenna 10 described herein includes the following attributes: (a) interleaved TX and RX aperture; wherein the TX and RX antennas both utilize the full size of the physical antenna (i.e., not ½ TX and ½ RX only); (b) based on a hybrid waveguide and printed circuit structure; (c) uses a two-level distribution mechanism to provide both TX and RX feeds (at the waveguide manifold level) in a means that is easy to manufacture and consists of minimal parts; (d) uses low loss printed circuit board material with an integrated radome; (e) uses a simplified PCB feed network within the printed circuit sub array that does not require any vias for changes between printed circuit layers; (f) uses a novel waveguide to PCB transition that provides a coupling mechanism from the macro level waveguide feed network into the localized sub array for both TX and RX stripline feed networks; (g) uses novel TX and RX printed patch antennas; (h) has an integrated transmit reject filter in the waveguide manifold; (i) uses ridged waveguide on the waveguide manifolds—transitioning from standard sized waveguide; and (j) right hand circular polarization TX and left-hand circular polarization RX.

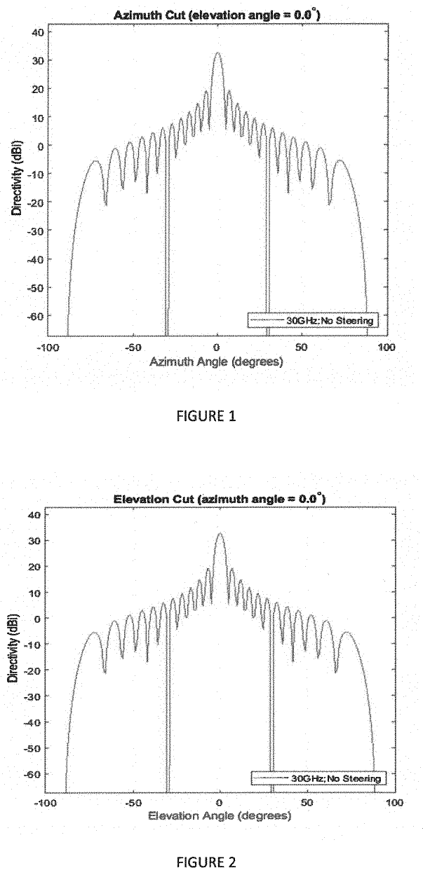

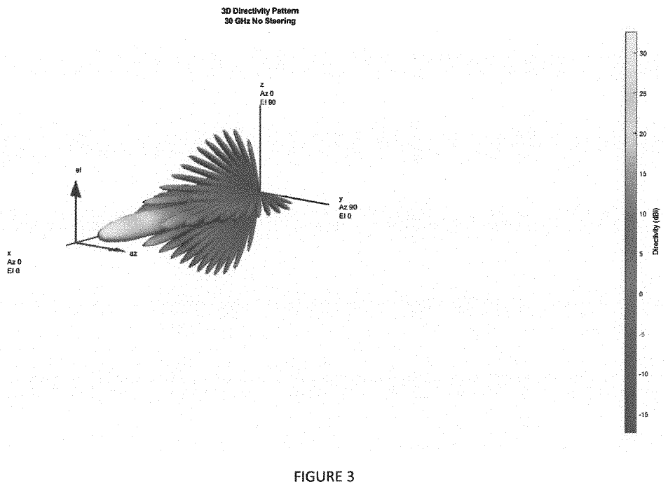

FIG. 1 illustrates an ideal Azimuth cut showing directivity of a flat panel array. FIG. 2 illustrates an ideal Elevation cut showing directivity of a flat panel array. FIG. 3 illustrates the directivity of a flat panel antenna.

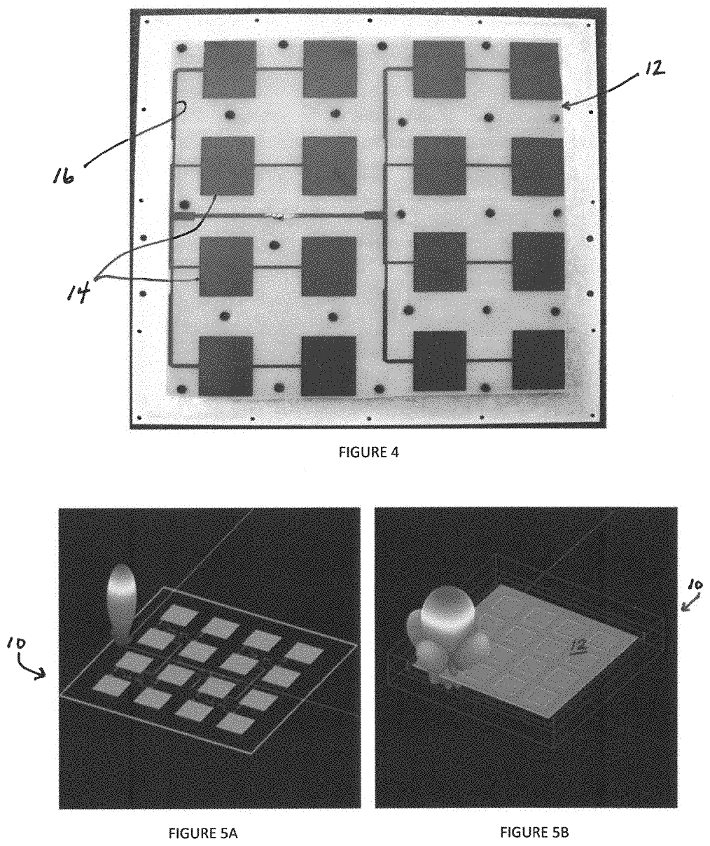

Referring to FIG. 4, the printed circuit board 12 is shown and includes a plurality of rectangular patches 14 and the feed network 16. FIGS. 5A and 5B illustrate the radiation patterns from printed antenna arrays 12 and shows how gain is increased at boresight.

The flat panel antenna 10 utilizes the combination of printed circuit board 12 and waveguide manifold 18, which is beneficial for several reasons including, but not limited to: (a) PCBs 12 can be used to make complex printed patch antennas with methods to improve bandwidth and axial ratio to optimize antenna performance; (b) these printed materials can be quite lossy at Ka band, and thus the localized feed network in the PCB 12 is kept to a minimum length; (c) it is easy to iterate the PCB artwork to tune antenna performance; (d) low layer count PCBs are typically less costly than high layer count, and do not require complicated layer changing vias; (e) the waveguide manifold 18 can be used for macro level RF distribution; and (f) the waveguide feed network is far less lossy when compared to PCB losses. PCB losses of high frequency material—1 dB/inch in manufacturing, waveguide losses may be on the order of 0.10 dB/inch.

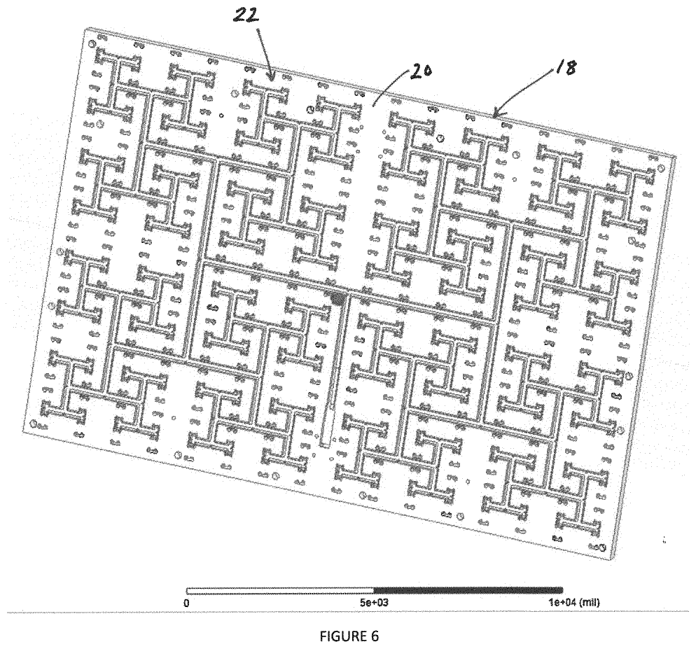

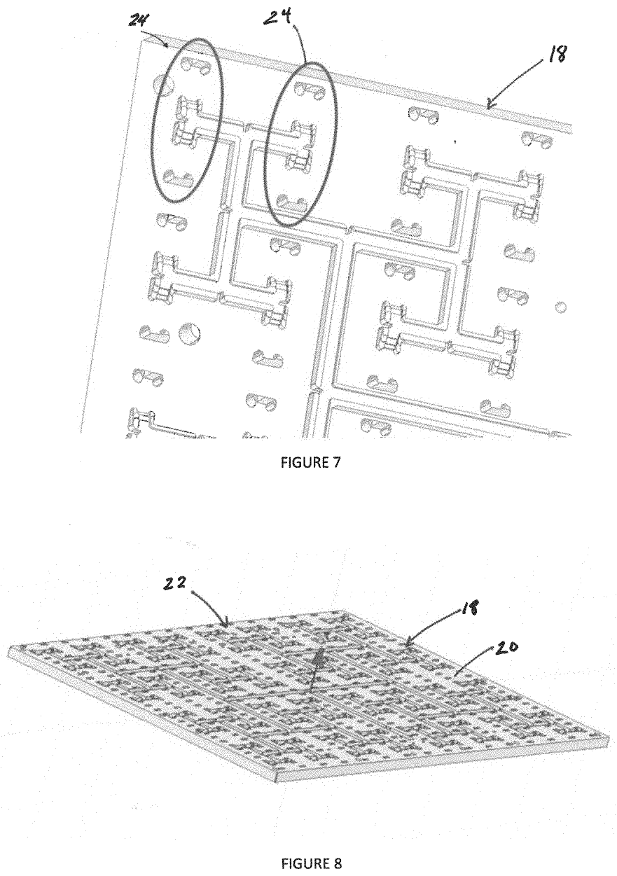

Referring to FIG. 6, the top side 20 of the waveguide manifold 18 includes transmit feed network (“TX feed”) 22. In one embodiment, the waveguide manifold is formed from aluminum. Referring to FIG. 7, the sub array 24 fed by the waveguide 18 is shown. FIG. 8 illustrates the waveguide 18 with the TX feed network 22 on the top side 20 and the receive feed network on the bottom side.

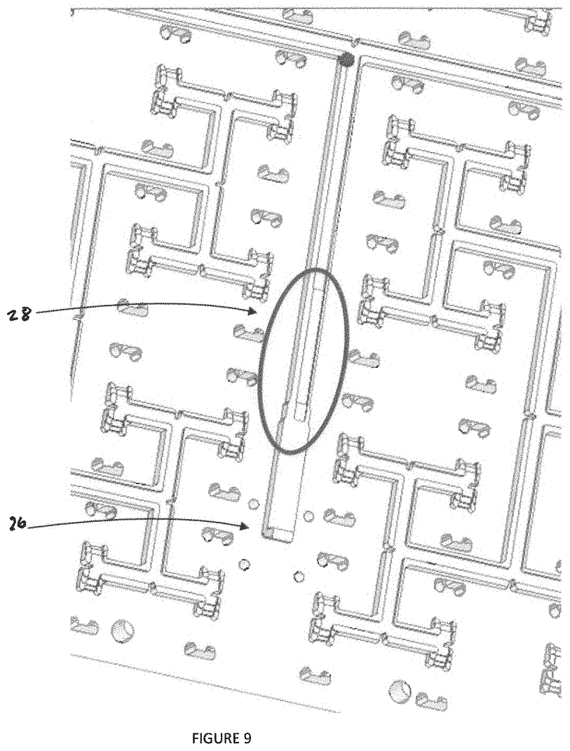

FIG. 9 illustrates a standard waveguide input port 26 and the transition region 28 from standard waveguide to ridged waveguide 29 for compact dimension.

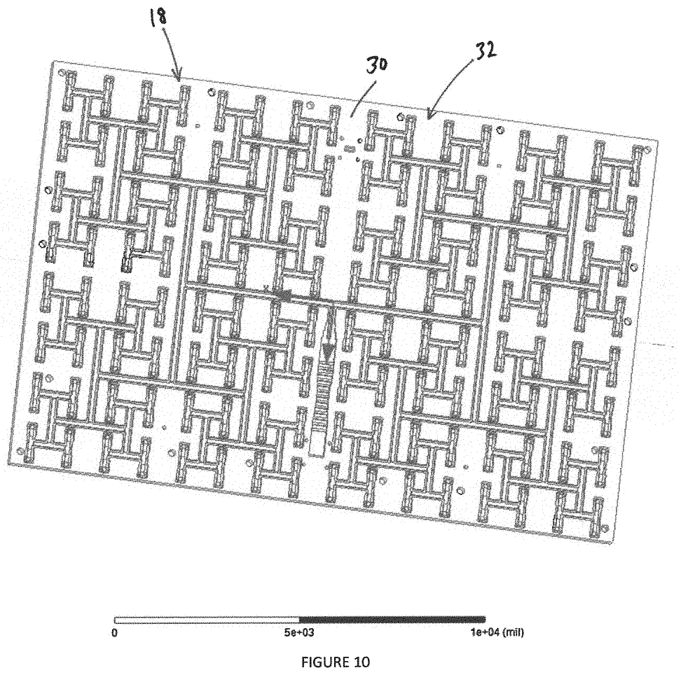

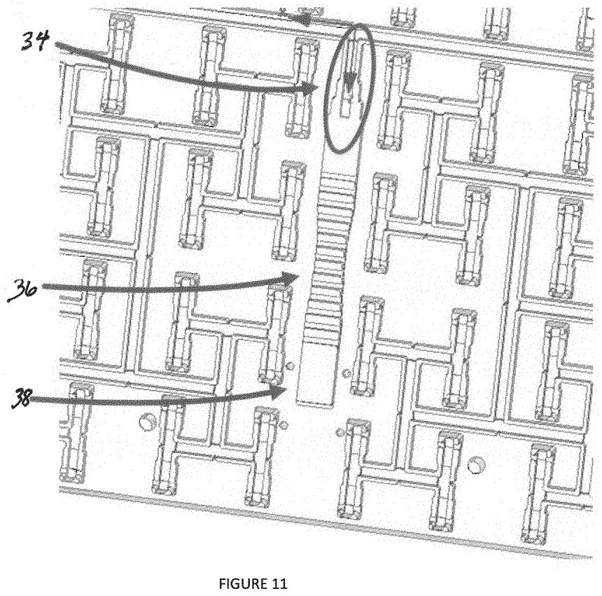

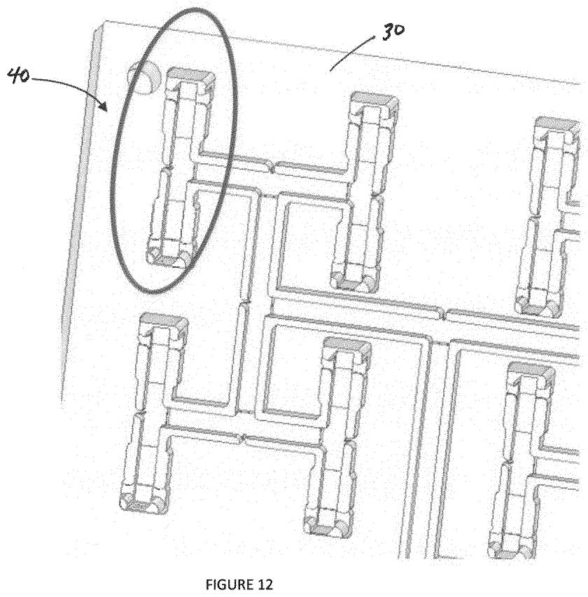

Referring now to FIGS. 10-12, the bottom side 30 of the waveguide 18 is shown, including the receive feed network (“RX feed”). The transition region 34 with integrated TX reject filter 36 are shown with a standard waveguide input port 38. Referring specifically to FIG. 12, the sub array 40 fed by the waveguide 18 is shown.

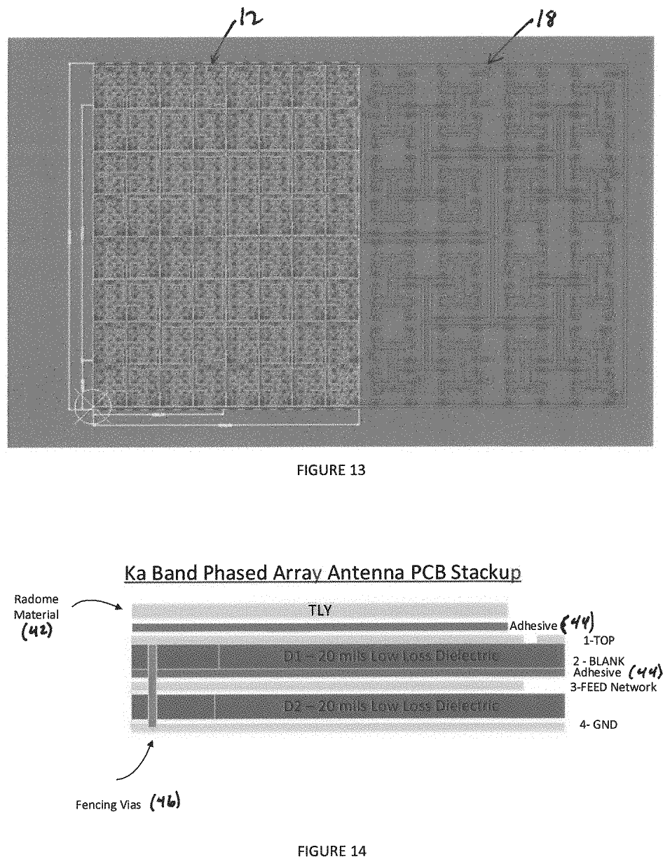

FIG. 13 illustrates the PCB 12 on the left and the waveguide manifold 18 on the right for illustrating how the PCB 12 is placed on top of the waveguide manifold 18.

FIG. 14 illustrates a Ka band phased array antenna PCB stackup 10 including integrated radome 42, multiple adhesive layers 44 and fencing vias 46.

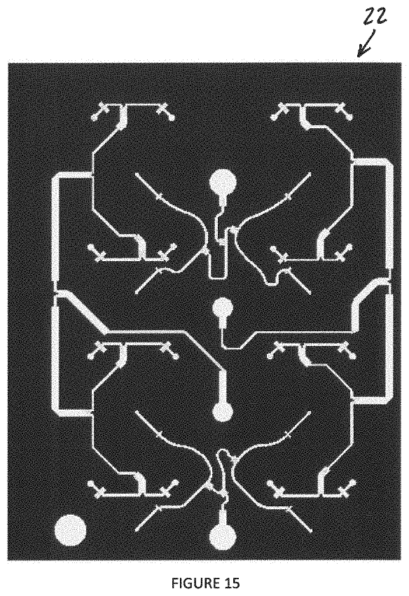

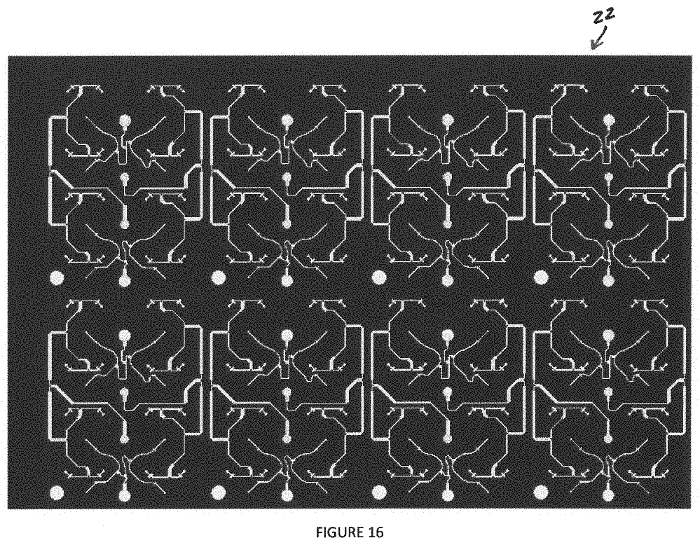

Referring to FIG. 15, the feed network 22 is shown including lightbulb-like elements that compromise the PCB segment of the waveguide 18 to PCB 12 transition, the striplines, and probes on the end of the lines which feed the patches as a proximity fed configuration. FIG. 16 illustrates multiple identical feed networks 22 replicated in the PCB 12 such that the same footprint is used repeatedly in the PCB 12. This allows easy scaling up or down of the size of the overall antenna 10 to meet gain requirements.

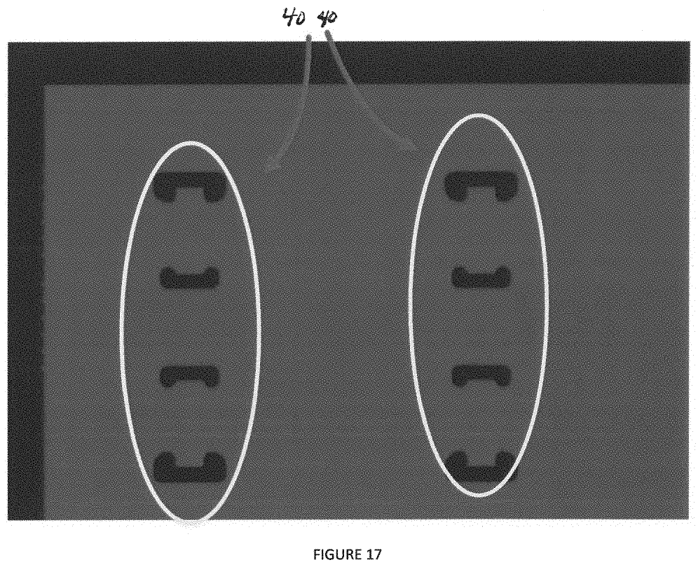

FIG. 17 illustrates the PCB ground layer 50 showing copper openings for interface from printed circuit board to waveguide manifold for 2 sub arrays—TX narrow in the middle, RX wider on the top (2ea×2). Two sub arrays 40 show the void in the lower stripline ground plane to allow waveguide to PCB transitions.

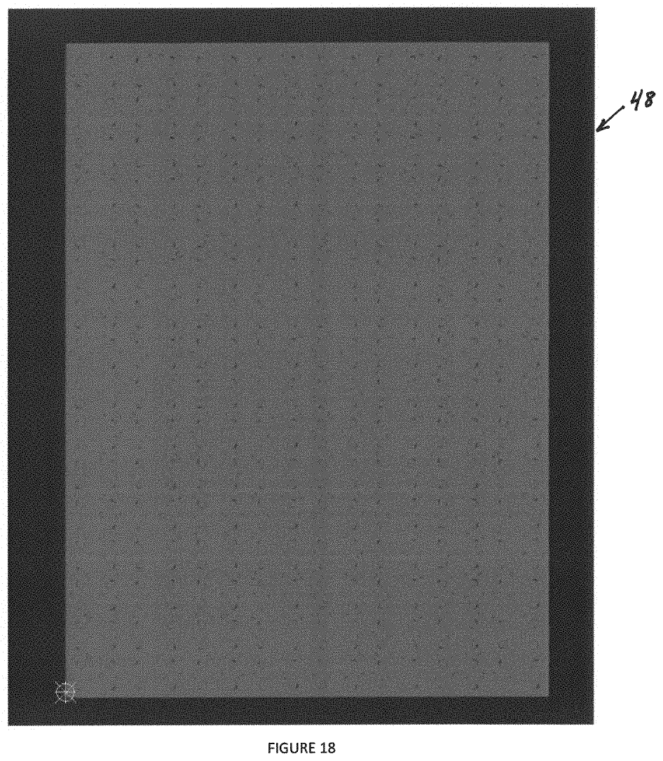

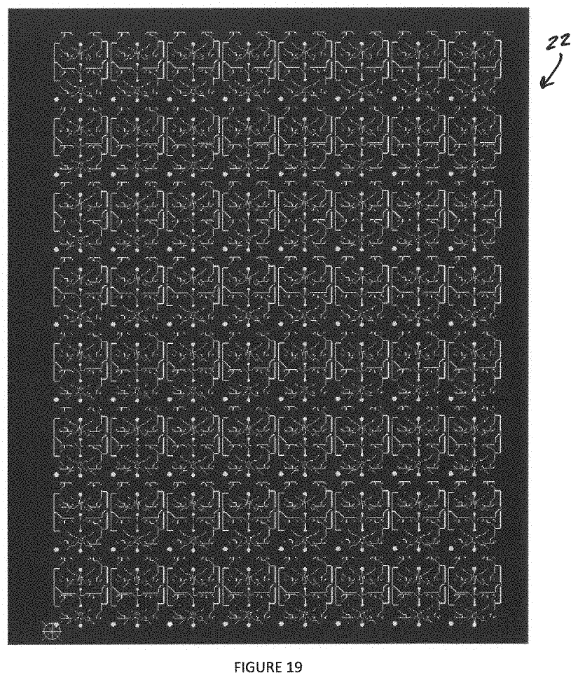

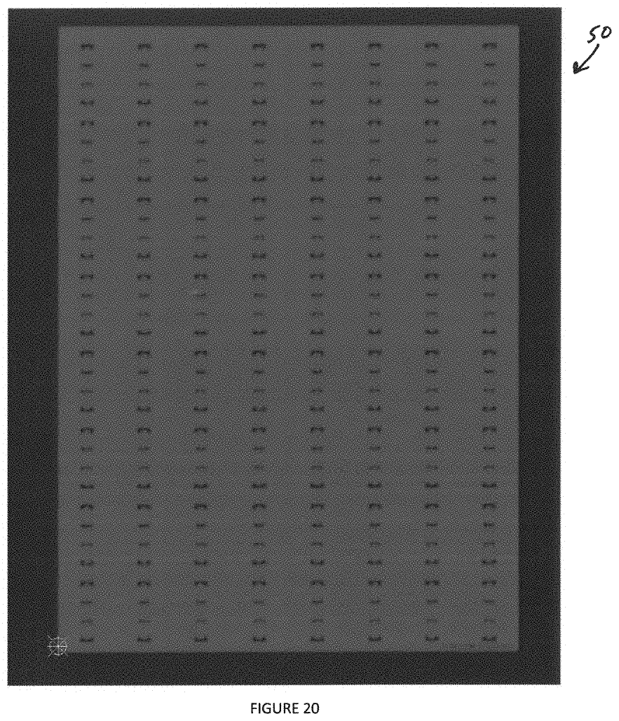

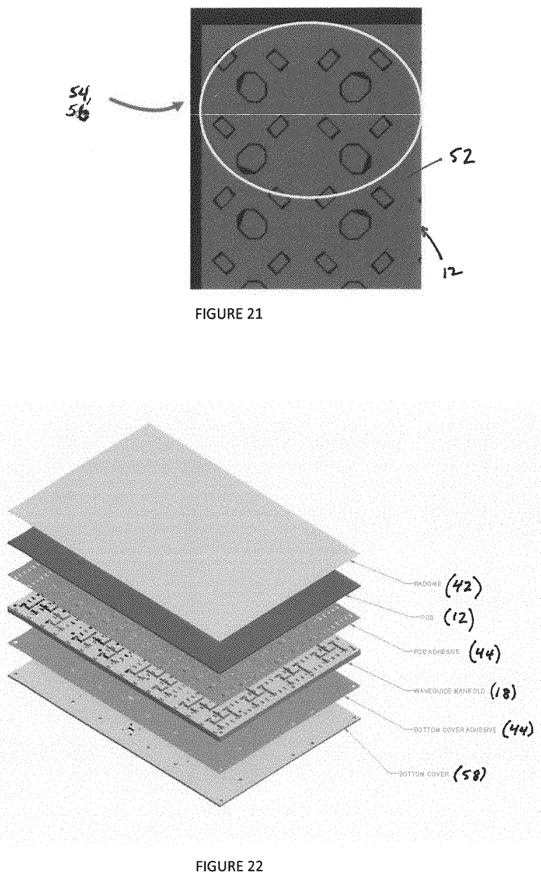

FIG. 18 illustrates the top copper layer 48 showing patches embedded in the ground plane. FIG. 19 illustrates the middle PCB feed layer showing stripline traces from each PCB to waveguide interface feeding both TX and RX sub arrays. FIG. 20 shows the bottom PCB layer 50 including ground plane with TX and RX interfaces between the PCB to the waveguide manifold. The slots allow coupling through the bottom of the PCB 12 to each sub array feed network. FIG. 21 shows the patches, including two TX patches 54 and one RX patch 56 on the top layer 52 of the PCB 12 (without radome).

FIG. 22 illustrates the PCB and waveguide manifold assembly 10 with a bottom cover 58 and conductive adhesives 44, as well as radome 42.

From the foregoing description of various embodiments of the invention, it will be apparent that many modifications may be made therein. It is understood that these embodiments of the invention are exemplifications of the invention only and that the invention is not limited thereto.

What is claimed is:

1. A flat panel antenna for satellite communications, the flat panel antenna comprising:
a printed circuit board (PCB) including a plurality of patches and a feed network;
a waveguide manifold including a transmit feed network on one side and a receive feed network on the opposite side;
a transition region on the transmit feed network wherein a waveguide input port transitions to a ridged waveguide for compact dimension;
a transition region on the transmit feed network wherein the waveguide input port transitions to the ridged waveguide for compact dimension;
an integrated transmit reject filter on the receive feed network; and
wherein the flat panel antenna is operable to provide right hand circular polarization TX and left-hand circular polarization RX.

2. A printed circuit board (PCB) and waiveguide manifold assembly for satellite communications, the PCB and waveguide assembly comprising:
a top cover layer with integrated radome;
a PCB layer including a plurality of patches and a feed network;
a waveguide manifold layer;
an adhesive between the PCB layer and the waveguide manifold layer;
a bottom cover;
an adhesive between the waveguide manifold layer and the bottom cover;
a transition region on the transmit feed network wherein a waveguide input port transitions to a ridged waveguide for compact dimension;
a transition region on the transmit feed network wherein the waveguide input port transitions to the ridged waveguide for compact dimension;
an integrated transmit reject filter on the receive feed network; and
wherein the flat panel antenna is operable to provide right hand circular polarization TX and left-hand circular polarization RX.
